(19) United States
(12) Patent Application Publication
(10) Pub. No.: US 2026/0155958 A1
(43) Pub. Date: Jun. 4, 2026

(54) KEY PROVISIONING DEVICE, SERVER, AND METHOD

(71) Applicant: HYUNDAI AUTOEVER CORP., Seoul (KR)

(72) Inventor: Ha Young Lee, Seoul (KR)

(73) Assignee: HYUNDAI AUTOEVER CORP., Seoul (KR)

(21) Appl. No.: 19/404,626

(22) Filed: Dec. 1, 2025

(30) Foreign Application Priority Data
Dec. 3, 2024 (KR) 10-2024-0177215

(51) Int. Cl. H04L 9/08

(52) U.S. Cl. CPC H04L 9/083

(57) ABSTRACT

A key provisioning device includes a communication circuit configured to receive, from a server, first key provisioning data including multiple key values and usage values for the keys. The key provisioning device also includes a control circuit configured to arbitrarily select at least one key value from among the multiple key values based on usage of a key required by a key data receiving device. The control circuit is also configured to generate second key provisioning data including the at least one key value. The control circuit is additionally configured to transmit the second key provisioning data to the key data receiving device via the communication circuit.

### CROSS REFERENCE TO RELATED APPLICATION

This application claims the benefit of and priority to Korea Patent Application No. 10-2024-0177215, filed on Dec. 3, 2024, the entire contents of which are hereby incorporated herein by reference.

### FIELD OF TECHNOLOGY

The present disclosure relates to a key provisioning technology.

### BACKGROUND

In earlier approaches to vehicle development and production, it was often typical for a vehicle's functions to remain unchanged after mass production. In such an environment, it was possible to embed a security key suitable for a specific purpose during the production stage of an electronic control unit (ECU), or to inject the security key at the time of vehicle mass production and then use the same security key throughout the vehicle's lifetime. Since the initially configured security key is maintained throughout the vehicle's life cycle, there is often no need for an update or modification procedure afterward.

At the time, security keys were configured based on the assumption that vehicle functions would remain fixed throughout operation. Since it was common for vehicles to operate without software or functional changes after mass production, it is likely that the system was designed to eliminate the need for additional security key management. Through this initial design and implementation approach, a framework was established in which the same security key could be used without modification throughout the vehicle's life time, effectively protecting the vehicle's control systems.

However, as vehicle technology continues to advance-particularly with the rapid development of sophisticated features such as autonomous driving-and as these technologies become increasingly likely to be actually deployed on roads, the traditional approach of using fixed security keys may no longer be suitable for the current and future automotive security environments. In addition to autonomous driving, a wide range of services and features that require connectivity between vehicles and external networks are being developed, further raising the level of security required for vehicles.

Recently, the concept of software-defined vehicles (SDVs) has been gaining more importance. In SDVs, vehicle functions are defined by software, allowing for continuous addition and improvement of various features through software updates. As the concept of software-defined vehicles emerges, more and more new technologies and services requiring security are coming out. Consequently, the number of security keys needed within the vehicle may increase significantly compared to the past, leading to greater complexity in security key management.

In an SDV, each time a new function is added or updated, there may be a need to generate and manage new security keys. This implies that both the number and variety of security keys required within the vehicle's overall security framework could continue to grow. While traditional approaches—such as using fixed security keys or managing security keys dependent on electronic control units (ECUs)—were sufficient when vehicle functions remained fixed, they may no longer be efficient in the context of SDVs.

Moreover, the traditional method of managing a security key by wired injection was designed under the assumption that vehicle functions would remain static. In environments where functions are frequently updated and modified through software, such methods can lead to unnecessary costs. For instance, physically accessing the vehicle each time a new security key is needed and injecting the security key via a wired connection is both time-consuming and costly. In the context of software-defined vehicles (SDVs), such an approach may be restrictive.

### SUMMARY

According to an aspect of the present disclosure, a flexible and efficient technology for key provisioning is provided. According to another aspect of the present disclosure, a technology that facilitates the distribution of security keys for new functions or security keys for updated functions in a manner suitable for SDVs is provided. According to yet another aspect of the present disclosure, a technology that ensures that security is not compromised even in a multiple key provisioning process is provided.

According to an embodiment of the present disclosure, a key provisioning device is provided. The key provisioning device includes a communication circuit configured to receive, from a server, first key provisioning data including multiple key values and usage values for the keys. The key provisioning device also includes a control circuit configured to arbitrarily select at least one key value from among the multiple key values based on the usage of a key required by a key data receiving device. The control circuit is also configured to generate second key provisioning data including the at least one key value. The control circuit is additionally configured to transmit the second key provisioning data to the key data receiving device via the communication circuit.

The control circuit may be configured to identify one or more key values corresponding to the usage of the key required by the key data receiving device, among the multiple key values, based on the usage values in the first key provisioning data, and arbitrarily select the at least one key value from among the one or more key values.

The control circuit may be configured to delete unused key values after transmitting the second key provisioning data.

The control circuit may be configured to receive the first key provisioning data from the server via wireless communication, and transmit the second key provisioning data to the key data receiving device using an in-vehicle communication network which is configured with wires or wirelessly.

The key data receiving device may be configured to update an existing key value with the at least one key value included in the second key provisioning data.

The control circuit may be configured to select at least one key value from among the multiple key values based on the usage value of a key included in a request message received from the key data receiving device.

The first key provisioning data may include a usage value indicating types of at least two devices, and the second key provisioning data may include a usage value indicating unique identifiers of the at least two devices.

The control circuit may be configured to specify, in the second key provisioning data, a unique identifier of the key provisioning device and a unique identifier of the key data receiving device received from the key data receiving device.

One of the multiple key values may be matched with multiple usages values.

The first key provisioning data may further include multiple certificates and usage values for the certificates.

According to another embodiment of the present disclosure provides, another key provisioning device is provided. The key provisioning device includes a computation circuit configured to generate multiple key values and generate first key provisioning data including the multiple key values and usage values for the keys, for usage-specific and device-specific keys required within a vehicle. The key provisioning device also includes a server communication circuit configured to transmit the first key provisioning data to a device installed on the vehicle.

The computation circuit may be configured to delete the multiple key values after the first key provisioning data is transmitted to the device.

Before deleting the multiple key values, the computation circuit may be configured to store hash operation values for the multiple key values.

According to yet another embodiment of the present disclosure, a key provisioning method is provided. The key provisioning method includes receiving, from a server, first key provisioning data including multiple key values and usage values for the keys. The key provisioning method also includes arbitrarily selecting at least one key value from among the multiple key values based on the usage of a key required by a key data receiving device. The key provisioning method additionally includes generating second key provisioning data including the at least one key value. The key provisioning method additionally further includes transmitting the second key provisioning data to the key data receiving device.

The key provisioning method may further include notifying the key data receiving device of the start of key provisioning; and receiving from the key data receiving device a request message including at least one usage value, wherein, in the arbitrarily selecting of at least one key value, at least one key value may be selected from among the multiple key values based on at least one usage value received from the key data receiving device.

The request message may include a unique identifier of the key data receiving device, and in the generating of the second key provisioning data, the unique identifier of the key data receiving device may be included in the second key provisioning data.

The key provisioning method may further include, when the at least one usage value received from the key data receiving device includes a usage intended for use only within the key data receiving device, deleting a key value corresponding to the usage intended for use only within the key data receiving device after transmitting the second key provisioning data.

One of the multiple key values may be matched with multiple usages values.

The key provisioning method may further include receiving a first key provisioning completion message from the key data receiving device, and transmitting a second key provisioning completion message to the server after the receiving of the first key provisioning completion message.

The multiple key values may be deleted from the server after the second key provisioning completion message is transmitted.

Embodiments of the present disclosure may provide a flexible and efficient technology for key provisioning. Embodiments of the present disclosure may also facilitate the distribution of security keys for new functions or security keys for updated functions in a manner suitable for SDVs. Embodiments of the present disclosure may also provide a technology that ensures that security is not compromised even in a multiple key provisioning process.

### BRIEF DESCRIPTION OF THE DRAWINGS

FIG. 1 is a diagram illustrating a configuration of a key provisioning system according to an embodiment of the present disclosure.

FIG. 2 is a diagram illustrating a configuration of main devices according to an embodiment.

FIG. 3 is a flowchart illustrating a key provisioning method according to an embodiment.

FIG. 4 is a first example of a device system according to an embodiment.

FIG. 5 is a first example of first key provisioning data according to an embodiment.

FIG. 6 is a first example of a second key provisioning information table according to an embodiment.

FIG. 7 is a first example of second key provisioning data according to an embodiment.

FIG. 8 is a second example of second key provisioning data according to an embodiment.

FIG. 9 is a third example of second key provisioning data according to an embodiment.

### DETAILED DESCRIPTION

Hereinafter, embodiments of the present disclosure are described in detail with reference to the accompanying drawings. It should be noted that, in assigning reference numerals to components in the drawings, the same components are given the same numerals as much as possible, even when the components are shown in different drawings. Furthermore, in describing the present disclosure, where it was determined that detailed descriptions of well-known components or functions would obscure the gist of the present disclosure, the detailed descriptions thereof have been omitted.

In describing the components of the present disclosure, terms such as first, second, A, B, (a), (b), and the like may be used. These terms are merely intended to distinguish one component from another, and the essence, sequence, or order of the components are not limited by the terms. Furthermore, when a component is described as being “connected”, “coupled”, or “accessed” to another component, it should be understood that the component may be directly linked or connected to another component or that the component may also be “connected”, “coupled”, or “accessed” to another component via yet another component provided therebetween.

When a component, controller, device, element, apparatus, circuit, unit, or the like of the present disclosure is described as having a purpose or performing an operation, function, or the like, the component, controller, device, element, apparatus, circuit, unit or the like should be considered herein as being “configured to” meet that purpose or to perform that operation or function. Each component, controller, device, element, apparatus, circuit, unit, and the like may separately embody or be included with a processor and a memory, such as a non-transitory computer readable media, as part of the apparatus.

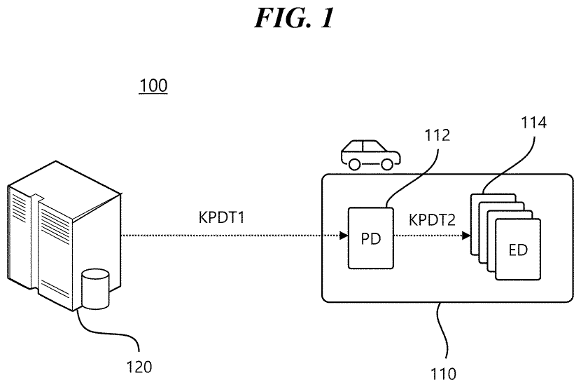

FIG. 1 is a diagram illustrating a configuration of a key provisioning system according to an embodiment of the present disclosure.

Referring to FIG. 1, a key provisioning system 100 may include a device system 110, a key provisioning server 120, etc. The device system 110 may be installed within a vehicle.

As used herein, the term “vehicle” refers to any type of transportation means for moving people or objects. For example, vehicles may include land-based transportation means such as cars, trucks, buses, or motorcycles, as well as other various transportation means such as aircraft, advanced air mobility (AAM), urban air mobility (UAM), drones, ships, or railway vehicles. For convenience of explanation, the following description focuses on automobiles as vehicles; however, the technical scope of the present disclosure is not limited thereto.

The device system 110 may include a primary device (PD) 112 and an end device (ED) 114. The primary device 112 plays a leading role in distributing keys within the device system 110, and is therefore also referred to as a key provisioning device.

The primary device 112 and the end device 114 may be connected via an in-vehicle communication network, which may be configured with wires or wirelessly.

The in-vehicle communication network may form a network environment in which the primary device 112 and the end device 114 can be interconnected. This communication network may support communication among various electronic control units within the vehicle, thereby enabling efficient data transmission.

The in-vehicle communication network may include various protocols and physical connection methods. Representative protocols may include Controller Area Network (CAN), Local Interconnect Network (LIN), Ethernet, and FlexRay. These protocols can be implemented with different data transmission speeds and processing methods, and may be used according to specific uses within the vehicle. For example, the CAN protocol may be used for communication between systems requiring real-time control, such as the engine and the transmission. LIN may be applied to accessory control which requires low-speed communication. Ethernet may be utilized for vehicle multimedia systems which require high-speed data transmission capable of transmitting more data.

The primary device 112 and the end device 114 may transmit and receive messages via the in-vehicle communication network. The primary device 112 may serve as a central data controller or relay on the network, while the end device 114 may be configured as a device that performs a specific function, such as a sensor or an actuator. The in-vehicle communication network facilitates smooth communication among various nodes, thereby supporting the operation of diverse vehicle functions through this communication process.

The in-vehicle communication network may use wire-based transmission media, which can transmit data through electrical signals. The transmission media may include unshielded twisted pair (UTP) cables, shielded twisted pair (STP) cables, or optical fiber cables, and may be selected based on the requirements of the network. Such physical connections may be designed to ensure the stability of data transmission.

The primary device 112 may be connected to the key provisioning server 120 via wireless communication.

The primary device 112 installed in the vehicle may be connected to the key provisioning server 120 via wireless communication. Wireless communication methods may include various technologies such as cellular networks, Wi-Fi, Bluetooth, and satellite communication. Such communication enables the vehicle to connect with other systems outside of the vehicle to send or receive data.

Over-The-Air (OTA) is an example method for a vehicle to wirelessly send and receive data to and from an external server. OTA may be used to remotely perform software updates, configuration changes, and certificate transfers. The primary device 112 may receive key provisioning data, including security keys or certificates from the key provisioning server 120, through OTA and store it in a security module within the vehicle. Through this process, a cellular network or Wi-Fi may be used to transmit data, thereby maintaining latest security updates and settings.

Wireless communication methods may include a cellular network, through which data can be transmitted and received using technologies such as Long Term Evolution (LTE) or 5G New Radio (NR). In this case, a telematics device installed in the vehicle may function as a communication module, enabling connectivity with networks outside the vehicle. Additionally, Wi-Fi-based communication may be used when the vehicle connects to an external network in a parking lot or service center. Through Wi-Fi, the vehicle may connect to the key provisioning server 120 and exchange data.

In the process of wireless communication, data security may be a critical consideration, and data may be transmitted in an encrypted form. The primary device 112 may transmit and receive data to and from the key provisioning server 120 using a security protocol, thereby preventing unauthorized access or data leakage.

A secure communication channel may be configured between the primary device 112 and the key provisioning server 120 and within the in-vehicle communication network. This secure communication channel may be configured using an encryption technology and an authentication mechanism in order to ensure safe data transmission. Such a secure communication channel helps prevent unauthorized viewing or tampering of data in a communication process.

To configure a secure communication channel in the in-vehicle communication network, such a protocol as transport layer security (TLS) may be used. TLS ensures that data is encrypted and transmitted in the communication process and provides a function that verifies the trustworthiness of a communication counterpart by authenticating the other party. Such a TLS protocol allows for secure data transmission and reception between the primary device 112 and the key provisioning server 120. When transmitting data, both symmetric key encryption and public key encryption may be employed to protect the data from unauthorized access and to ensure data integrity.

To configure a secure communication channel within the in-vehicle communication network, such a technology as message authentication code (MAC) or hash-based message authentication code (HMAC) may be employed. These technologies may provide functionality for authenticating the origin of messages transmitted over a communication network and verifying data integrity. For example, when using the controller area network (CAN) protocol, which basically does not include security features, an additional MAC or HMAC algorithm may be applied to verify and authenticate data integrity.

Additionally, in a secure communication channel, a security key may be required to enable encrypted communication between communication nodes within the vehicle. This key can be provided from the key provisioning server 120. When the key is provided, it may be sent in an encrypted form to maintain security. The primary device 112 may use the received key to encrypt and decrypt data within the in-vehicle communication network.

In an embodiment, to maintain a secure communication channel, an authentication mechanism for verifying the identity of the other party may be used. A certificate-based authentication method may be used, allowing both communicating parties to mutually confirm that they are trustworthy entities. Certificates may be managed using a public key infrastructure (PKI), and the primary device 112 and the key provisioning server 120 may set up a secure communication channel based on these certificates.

The primary device 112 may receive first key provisioning data KPDT1 (Key Provisioning Data 1) from the key provisioning server 120. The first key provisioning data KPDT1 includes key values required for the device system 110, and may include usage values for the keys. For example, if the usage values are expressed as U1 and U2, the first key KEY1 may be matched with U1 and included in the first key provisioning data KPDT1, and the second key KEY2 may be matched with U2 and included in the key provisioning data KPDT1.

Furthermore, the primary device 112 may identify the usage of a key required by the end device 114, select a key value based on the usage of the key, and include the key value in the second key provisioning data KPDT2 and transmit it to the end device 114.

In this method, only data related to the key is transmitted, allowing the key to be distributed without affecting the software installed on each device. Additionally, since the server 120 organizes and distributes key values based on each vehicle, the keys may be distributed in a way that suits the conditions of every vehicle. Key distribution may be automated because the entire process does not require human intervention. Moreover, when the server 120 sends key values to the primary device 112, it does not specify which device will use the key values. Instead, the primary device 112 determines which device will use the key values, eliminating the keys'dependency on controllers. Even if a key is leaked, its intended usage cannot be identified, thereby enhancing security.

In an embodiment, the key provisioning server 120 may delete the key values after the distribution of the generated key values is complete. The primary device 112 may delete the key values if it does not use them after distribution. This may help reduce the risk of key leakage. Before deleting the key values, the key provisioning server 120 may retain the hash operation values of the keys. These hash operation values may be used to verify whether the correct keys were distributed to the vehicle in case of an error.

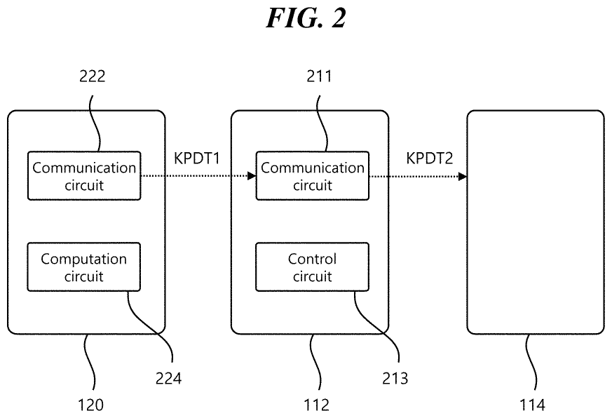

FIG. 2 is a diagram illustrating a configuration of main devices according to one embodiment.

Referring to FIG. 2, the key provisioning server 120 may include a communication circuit 222 and a computation circuit 224. The primary device 112 may include a communication circuit 211 and a control circuit 213. For ease of understanding, the communication circuit 222 included in the key provisioning server 120 is referred to as a server communication circuit 222, and the communication circuit 211 included in the primary device 112 is referred to as a device communication circuit 211.

A computation circuit 224 of the server may generate multiple key values for usage-specific and device-specific keys required within one vehicle. For example, the computation circuit 224 may generate two key values for usage U1 and one key value for usage U2. The computation circuit 224 may find the number of key values needed for each vehicle and generate the key values accordingly.

Additionally, the computation circuit 224 may generate usage values for the keys. The computation circuit 224 may identify the key values required for each vehicle and the usages of the keys. The computation circuit 224 may generate the key values accordingly and match each key value with a corresponding usage value.

The computation circuit 224 may then generate the first key provisioning data KPDT1, which includes the generated key values and the usage values of the keys.

The server communication circuit 222 may transmit the first key provisioning data KPDT1 via communication to a device installed in a vehicle-for example, the device communication circuit 211.

After the first key provisioning data KPDT1 has been transmitted to a device, for example, to the primary device 112, the computation circuit 224 may delete the generated multiple key values. The key provisioning server 120 may receive a key provisioning completion message from the primary device 112, and the computation circuit 224 may delete the multiple key values after receiving the key provisioning completion message. The primary device 112 may send the key provisioning completion message to the key provisioning server 120 once the key provisioning is complete.

Before deleting the multiple key values, the calculation circuit 224 may store hash operation values for the multiple key values. These stored hash operation values may be used to verify whether the distributed keys match the vehicle in case of an error.

The device communication circuit 211 may receive from the server 120 first key provisioning data KPDT1 including multiple key values and usage values for the keys. Then, once second key provisioning data KPDT2 is generated by the control circuit 213, the second key provisioning data KPDT2 may be transmitted to the end device 114.

The device communication circuit 211 may receive the first key provisioning data KPDT1 from the server 120 via wireless communication, and may transmit the second key provisioning data KPDT2 to the end device 114 using the in-vehicle communication network which is configured with wires or wirelessly.

The control circuit 213 may arbitrarily select at least one key value from among the multiple key values, based on the usage of a key required by the end device 114. Then, the control circuit 213 may generate second key provisioning data KPDT2 including the at least one key value, and transmit the second key provisioning data KPDT2 to the end device 114 through the device communication circuit 211.

The control circuit 213 may identify one or more key values corresponding to the usage of the key required by the end device 114, among the multiple key values, based on the usage values in the first key provisioning data KPDT1, and may arbitrarily select the aforementioned at least one key value from among the one or more key values. For example, the first key provisioning data KPDT1 may include a first key value KEY1, a second key value KEY2, and a third key value KEY3, and the first key value KEY1 may be matched with U1, the second key value KEY2 may be matched with U2, and the third key value KEY3 may be matched with U1. In this case, when the end device 114 requests a key value for the usage U1, the control circuit 213 may arbitrarily select a key value from the first and third key values KEY1 and KEY3 corresponding to U1.

After transmitting the second key provisioning data KPDT2, the control circuit 213 may delete key values that are not used by itself. For example, if U2 is a key value that is used only within the end device 114, the control circuit 213 may include the second key value KEY2 in the second key provisioning data KPDT2 and transmit it, and may then delete the remaining second key value KEY2 from the primary device 112.

The end device 114 may update an existing key value with a key value included in the second key provisioning data KPDT2, and may use it for a newly created function. For example, the end device 114 may use the third key value KEY3 received for the usage U1 to update an existing key value, and may use the second key value KEY2 received for the usage U2 for a new function.

The end device 114 may receive the second key provisioning data KPDT2 from the primary device 112 through a request.

The primary device 112 may select at least one key value from among the multiple key values included in the first key provisioning data KPDT1, based on the usage value of a key included in a request message received from the end device 114, and may transmit it to the end device 114.

The request message may include a usage value required by the end device 114, as well as a unique identifier of the end device 114.

U1 may be a usage value for communication between at least two devices. For the usage U1, the first key provisioning data KPDT1 may contain only the types of at least two devices communicating with each other. For example, the first key provisioning data KPDT1 may specify that the third key value KEY3 is intended for communication between a first-type controller and a second-type controller.

The primary device 112 may identify the unique identifier of the end device 114 received from the end device 114 and specify this unique identifier in the second key provisioning data KPDT2. For example, the primary device 112 may replace the second-type controller specified in the first key provisioning data KPDT1 with the unique identifier of the end device 114 in the second key provisioning data KPDT2 and may replace the first-type controller specified in the first key provisioning data KPDT1 with the unique identifier of its own device unique identifier in the second key provisioning data KPDT2.

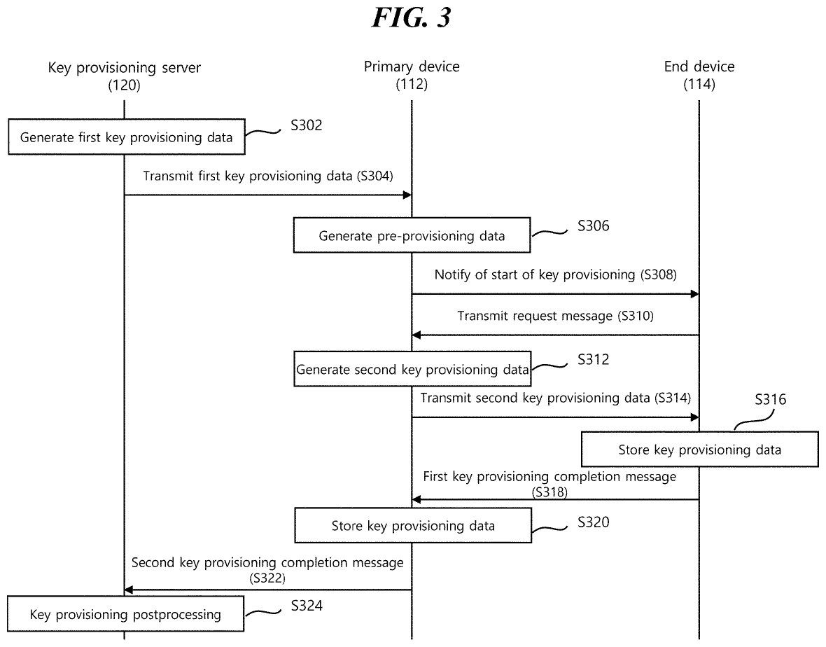

FIG. 3 is a flowchart illustrating a key provisioning method according to one embodiment.

Referring to FIG. 3, in an operation S302, the key provisioning server 120 may generate first key provisioning data including multiple key values and usage values for the keys. The key provisioning server 220 may generate the first key provisioning data according to the usages and number of keys required for each vehicle.

In an operation S304, the primary device 112 may receive the first key provisioning data including multiple key values and usage values for the keys, from the key provisioning server 120.

In an operation S306, the primary device 112 may generate pre-provisioning data. The primary device 112 may identify the number and usages of keys from the first key provisioning data. Also, the primary device 112 may check key provisioning information tables according to the usages. These key provisioning information tables may be included in the first key provisioning data.

In an operation S308, the primary device 112 may notify the end device 114 of the start of key provisioning.

In an operation S310, the primary device 112 may receive from the end device 114 a request message including at least one usage value.

Based on the usage of a key required by the end device 114, the primary device 112 may arbitrarily select at least one key value from among the multiple key values. In an embodiment, the primary device 112 may select at least one key value from among the multiple key values based on at least one usage value included in the request message received from the end device 114.

In an operation S312, the primary device 112 may generate second key provisioning data including the at least one key value thus selected.

The request message received from the end device 114 may include the unique identifier of the end device. When generating the second key provisioning data, the primary device 112 may include the unique identifier of the end device in the second key provisioning data.

In an operation S314, the primary device 112 may transmit the second key provisioning data to the end device 114.

In an operation S316, the end device 114 may store the received key provisioning data and use the key values contained therein.

The end device 114 may use the key values for communication with another device (key data receiving device)—for example, the primary device 112—or may use them only internally. The values representing these usages may be included in the request message and transmitted to the primary device 112.

After transmitting the second key provisioning data to the end device 114, the primary device 112 may delete a key value corresponding to a usage intended for use only within the end device 114.

For example, in an operation S318, the primary device 112 may receive a message indicating that key provisioning is completed-a first key provisioning completion message—from the end device 114, and may delete from its memory a key value not used by itself—for example, a key value intended for use only within the end device 114.

In an operation S320, when receiving the first key provisioning completion messages from all end devices managed by the primary device 112, the primary device 112 may store the key provisioning data related to the key values it uses.

In an operation S322, the primary device 112 may then transmit a message indicating that provisioning of all keys is completed—a second key provisioning completion message—to the key provisioning server 120.

In an operation S324, upon receiving the second key provisioning completion message, the key provisioning server 120 may delete the multiple key values from the server. Before deletion, the key provisioning server 120 may store hash operations values for the multiple key values.

This embodiment is described in more detail through specific examples below.

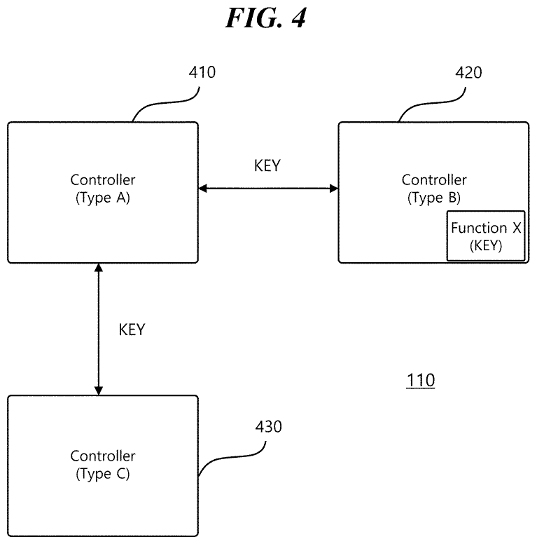

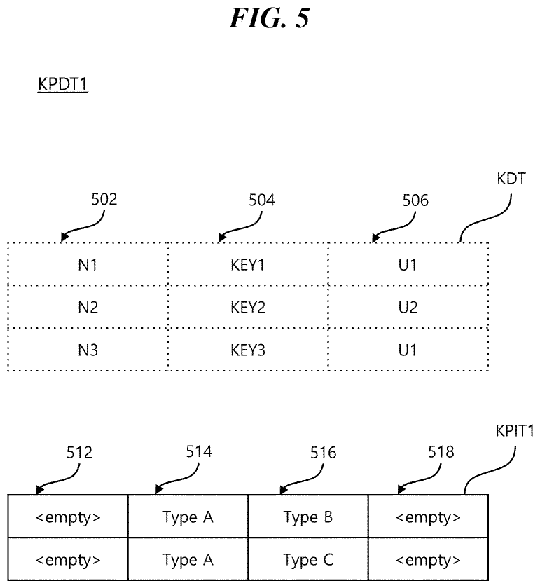

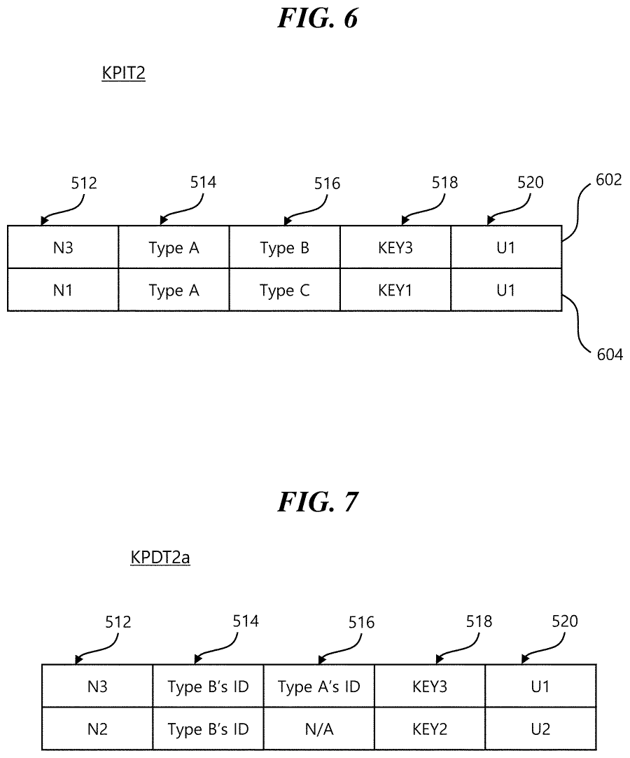

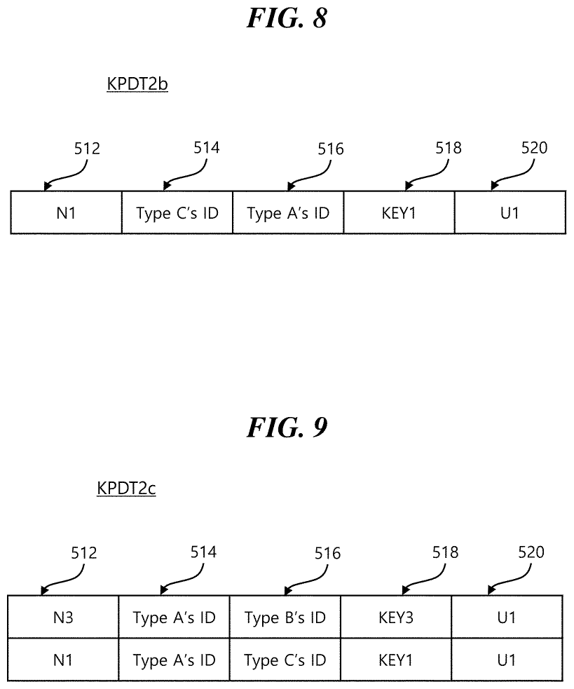

FIG. 4 is a first example of a device system according to an embodiment. FIG. 5 is a first example of first key provisioning data according to an embodiment. FIG. 6 is a first example of a second key provisioning information table according to an embodiment. FIG. 7 is a first example of second key provisioning data according to an embodiment. FIG. 8 is a second example of second key provisioning data according to an embodiment. FIG. 9 is a third example of second key provisioning data according to an embodiment.

In the examples shown in FIGS. 4-9 , the device system 110 may include a first controller 410, a second controller 420, and a third controller 430. The first controller 410 may be a Type A controller, the second controller 420 may be a Type B controller, and the third controller 430 may be a Type C controller.

One key value may be required for communication between the first controller 410 and the second controller 420, another key value may be required for communication between the first controller 410 and the third controller 430, and yet another key value may be required for an internal function X of the second controller 420.

In this example, the first controller 410 operates as a primary device, and the second controller 420 and the third controller 430 may operate as end devices.

The key provisioning server is aware of the demand for these key values, and may also know the type of each controller. Based on this information, the key provisioning server may generate the first key provisioning data KPDT1.

The first key provisioning data KPDT1 may include key data KDT and a first key provisioning information table KPIT1 (Key Provisioning Information Table 1).

The key data KDT may include a data number 502, a key value 504, and a usage value 506. For example, the key data KDT may include a first key value KEY1 and a first usage value U1 which correspond to a first data number N1, a second key value KEY2 and a second usage value U2 which correspond to a second data number N2, and a third key value KEY3 and the first usage value U1 which correspond to a third data number N3.

The first key provisioning information table KPIT1 may be formed differently for different usage values. For example, the first key provisioning data KPDT1 may include a first key provisioning information table KPIT1 corresponding to the first usage value U1. The key provisioning information table KPIT1 may also be formed for the second usage value U2; however, if the second usage value U2 is intended for only a single device, such a table may not be created.

The first key provisioning information table KPIT1 may include a data number 512, a first device unique identifier 514, a second device unique identifier 516, and a key value 518. At this time, the first key provisioning information table KPIT1, which is created and transmitted by the key provisioning server, may be formed with the data number 512 and the key value 518 left empty. Furthermore, the first device unique identifier 514 and the second device unique identifier 516 may contain not a device unique identifier but only a controller type value.

After receiving the first key provisioning data KPDT1, the primary device may modify the first key provisioning information table KPIT1 to construct a second key provisioning information table KPIT2. This second key provisioning information table KPIT2 may then be used as pre-provisioning data.

The second key provisioning information table KPIT2 may include a data number 512, a first device unique identifier 514, a second device unique identifier 516, a key value 518, and a usage value 520.

The primary device may check the controller types specified in the first device unique identifier 514 and second device unique identifier 516 from the first key provisioning information table KPIT1 for each usage and arbitrarily select a key value required for those types. For example, the primary device may arbitrarily select a key value required for Type A and Type B from the key values KEY1 and KEY3 corresponding to the first usage value U1. Also, the primary device may arbitrarily select a key value required for Type A and Type C from the key values KEY1 and KEY3 corresponding to the first usage value U1.

The primary device may specify the selected key value and the data number of the key value in the second key provisioning information table KPIT2. Additionally, the primary device may further specify a usage value to generate pre-provisioning data.

Furthermore, the primary device may receive usage values and unique identifiers from the end devices, and use this information to generate second key provisioning data KPDT2a, KPDT2b, and KPDT2c.

The primary device may separate different rows 602 and 604 of the second key provisioning information table KPIT2 according to controller, specify the unique identifier received from each controller in the position of the first device unique identifier 514, and specify the unique identifier of the primary device in the second device unique identifier 516.

For key values used only by the end devices, the second device unique identifier 516 may be marked as N/A (not available).

After creating the second key provisioning data KPDT2a and KPDT2b for the end devices, the primary device may generate the second key provisioning data KPDT2c for the primary device by using information in request messages received from the end devices and its own information.

The primary device may then transmit the second key provisioning data to the end devices or store it therein.

Although not illustrated in the drawings, one or more of the multiple key values included in the first key provisioning data may be matched with multiple usage values.

In one embodiment, it has been described that the first key provisioning data includes multiple key values and usage values for the keys; however, multiple certificates may be included instead of the multiple key values. Alternatively, the first key provisioning data may include multiple certificates and usage values for the certificates, in addition to the multiple key values and the usage values for the keys.

As described above, according to embodiments of the present disclosure, it is possible to provide a flexible and efficient technology for key provisioning. Furthermore, according to embodiments of the present disclosure, it is also possible to facilitate the distribution of security keys for new functions and security keys for updated features in a manner suitable for SDVs. Furthermore, according to embodiments of the present disclosure, it is possible to provide a technology that security is not compromised even in a multiple key provisioning process.

As used herein, terms such as “include”, “comprise,” or “have” are to be interpreted as indicating the possibility of inclusion, unless explicitly stated otherwise, and therefore should not be construed as excluding other components but rather as allowing the inclusion of additional components. All terms, including technical and scientific terms, are to be interpreted as having the meanings commonly understood by those of ordinary skill in the art to which the present disclosure pertains, unless otherwise defined. Commonly used terms, such as those defined in dictionaries, should be interpreted in accordance with their contextual meaning in the relevant technical field, and unless expressly defined in the present disclosure, should not be interpreted in an idealized or overly formal sense.

The foregoing description is merely illustrative of the technical concept of the present disclosure, and those having ordinary skill in the art to which the present disclosure pertains should understand that various modifications and alterations may be made without departing from the essential characteristics of the disclosure. Accordingly, the embodiments disclosed herein are intended to explain, not to limit, the technical concept of the present disclosure, and the scope of the technical concept should not be construed as being limited to these embodiments. The scope of protection of the present disclosure shall be interpreted based on the claims below, and all technical concepts falling within an equivalent scope shall be construed as being included within the scope of rights of the present disclosure.

What is claimed is:

1. A key provisioning device comprising:
a communication circuit configured to receive, from a server, first key provisioning data including multiple key values and usage values for the keys; and
a control circuit configured to:
arbitrarily select at least one key value from among the multiple key values based on usage of a key required by a key data receiving device,
generate second key provisioning data including the at least one key value, and
transmit the second key provisioning data to the key data receiving device via the communication circuit.

2. The key provisioning device of claim 1, wherein the control circuit is configured to:
identify one or more key values corresponding to the usage of the key required by the key data receiving device, among the multiple key values, based on the usage values in the first key provisioning data; and
arbitrarily select the at least one key value from among the one or more key values.

3. The key provisioning device of claim 1, wherein the control circuit is configured to delete unused key values after transmitting the second key provisioning data.

4. The key provisioning device of claim 1, wherein the control circuit is configured to:
receive the first key provisioning data from the server via wireless communication; and
transmit the second key provisioning data to the key data receiving device using an in-vehicle communication network which is configured with wires or wirelessly.

5. The key provisioning device of claim 1, wherein the key data receiving device is configured to update an existing key value with the at least one key value included in the second key provisioning data.

6. The key provisioning device of claim 1, wherein the control circuit is configured to select at least one key value from among the multiple key values based on a usage value of a key included in a request message received from the key data receiving device.

7. The key provisioning device of claim 1, wherein:
the first key provisioning data includes a usage value indicating types of at least two devices; and
the second key provisioning data includes a usage value indicating unique identifiers of the at least two devices.

8. The key provisioning device of claim 7, wherein the control circuit is configured to specify, in the second key provisioning data, a unique identifier of the key provisioning device and a unique identifier of the key data receiving device received from the key data receiving device.

9. The key provisioning device of claim 1, wherein one of the multiple key values is matched with multiple usages values.

10. The key provisioning device of claim 1, wherein the first key provisioning data further includes multiple certificates and usage values for the certificates.

11. A key provisioning device comprising:
a computation circuit configured to:
generate multiple key values, and
generate first key provisioning data including the multiple key values and usage values for the keys, for usage-specific and device-specific keys required within a vehicle; and
a server communication circuit configured to transmit the first key provisioning data to a device installed on the vehicle.

12. The key provisioning device of claim 11, wherein the computation circuit is configured to delete the multiple key values after the first key provisioning data is transmitted to the device.

13. The key provisioning device of claim 12, wherein, before deleting the multiple key values, the computation circuit is configured to store hash operation values for the multiple key values.

14. A key provisioning method comprising:
receiving, from a server, first key provisioning data including multiple key values and usage values for the keys;
arbitrarily selecting at least one key value from among the multiple key values based on usage of a key required by a key data receiving device;
generating second key provisioning data including the at least one key value; and
transmitting the second key provisioning data to the key data receiving device.

15. The key provisioning method of claim 14, further comprising:
notifying the key data receiving device of a start of key provisioning; and
receiving from the key data receiving device a request message including at least one usage value,
wherein arbitrarily selecting the at least one key value includes selecting the at least one key value from among the multiple key values based on at least one usage value received from the key data receiving device.

16. The key provisioning method of claim 15, wherein:
the request message includes a unique identifier of the key data receiving device; and
generating the second key provisioning data includes including the unique identifier of the key data receiving device in the second key provisioning data.

17. The key provisioning method of claim 15, further comprising, when the at least one usage value received from the key data receiving device includes a usage intended for use only within the key data receiving device, deleting a key value corresponding to the usage intended for use only within the key data receiving device after transmitting the second key provisioning data.

18. The key provisioning method of claim 14, wherein one of the multiple key values is matched with multiple usages values.

19. The key provisioning method of claim 14, further comprising:
receiving a first key provisioning completion message from the key data receiving device; and
transmitting a second key provisioning completion message to the server after the receiving of the first key provisioning completion message.

20. The key provisioning method of claim 19, wherein the multiple key values are deleted from the server after the second key provisioning completion message is transmitted.
